(19) United States
(12) Patent Application Publication
(10) Pub. No.: US 2024/0218536 A1
(43) Pub. Date: Jul. 4, 2024

(54) SOLID OXIDE CELL STACK COMPRISING INTEGRATED INTERCONNECT, SPACER AND MANIFOLD

(71) Applicant: Topsoe A/S, Kgs. Lyngby (DK)

(72) Inventors: Thomas Heiredal-Clausen, Birkerød (DK); Jeppe Rass-Hansen, Copenhagen V (DK); Tobias Holt Nørby, Glostrup (DK); Rainer Küngas, Peetri (EE); Bengt Peter Gustav Blennow, Humlebæk (DK)

(73) Assignee: Topsoe A/S, Kgs. Lyngby (DK)

(21) Appl. No.: 18/289,188

(22) PCT Filed: Feb. 8, 2022
(86) PCT No.: PCT/EP2022/052991

§ 371 Date: Nov. 1, 2023

(30) Foreign Application Priority Data
May 3, 2021 (EP) 21171855.6

(51) Int. Cl. C25B 9/65; C25B 9/19; C25B 9/77; C25B 13/07; H01M 8/0247; H01M 8/0258; H01M 8/0282; H01M 8/12; H01M 8/2484

(52) U.S. Cl. CPC C25B 9/66; C25B 9/19; C25B 9/77; C25B 13/07; H01M 8/0247; H01M 8/0258; H01M 8/0282; H01M 2008/1293; H01M 8/2484

(57) ABSTRACT

A Solid Oxide Cell stack has an integrated interconnect, spacer and manifold, which is formed by bending a surplus part of the plate interconnect 180° to form a spacer part on top of the interconnect and connected to the interconnect at least by the bend and comprising overlapping primary and secondary gas inlet openings in adjacent layers in fluid connection.

### FIELD OF THE INVENTION

The invention relates to a Solid Oxide Cell (SOC) stack, in particular a Solid Oxide Electrolysis Cell (SOEC) stack or a Solid Oxide Fuel Cell (SOFC) stack, comprising an integrated interconnect and spacer, in particular an integrated interconnect and spacer comprising integrated gas manifold(s) and channels.

### BACKGROUND OF THE INVENTION

This invention can generally be used in a SOC stack—thus both in SOEC and SOFC mode even though for simplicity some parts of the description below relates to SOEC mode.

In SOC stacks which has an operating temperature between 600° C. and 1000° C., preferably between 600° C. and 850° ° C., several cell units are assembled to form the stack and are linked together by interconnects. Interconnects serve as a gas barrier to separate the anode and cathode sides of adjacent cell units, and at the same time they enable current conduction between the adjacent cells, i.e. between an anode of one cell and a cathode of a neighbouring cell. Further, interconnects are normally provided with a plurality of flow paths for the passage of process gas on both sides of the interconnect. To optimize the performance of a SOC stack, a range of positive values should be maximized without unacceptable consequence on another range of related negative values which should be minimized. Some of these values are:

| VALUES TO BE MAXIMIZED | VALUES TO BE MINIMIZED |
|---|---|
| Process gas utilization | Cost |
| electrical efficiency | Dimensions |
| lifetime | production time |
| | fail rate |
| | number of components |
| | Parasitic loss (heating, |
| | cooling, blowers . . .) |
| | material use |

Almost all the above listed values are interrelated, which means that altering one value will impact other values. Some relations between the characteristics of process gas flow in the cells and the above values are mentioned here:

### Process Gas Utilization:

The flow paths on the interconnect should be designed to seek an equal amount of process gas to each cell in a stack, i.e. there should be no flow—“short-cuts” through the stack.

### Parasitic Loss:

Design of the process gas flow paths in the SOC stack and its cell units should seek to achieve a low pressure loss per flow volume, which will reduce the parasitic loss to blowers.

### Electric Efficiency:

The interconnect leads current between the anode and the cathode layer of neighbouring cells. Hence, to reduce internal resistance, the electrically conducting contact points (hereafter merely called “contact points”) of the interconnect should be designed to establish good electrical contact to the electrodes (anode and cathode) and the contact points should no where be far apart, which would force the current to run through a longer distance of the electrode with resulting higher internal resistance.

### Lifetime:

It is desirable that the lifetime of an SOC stack is maximized, i.e. that in SOFC mode it can be used to produce as much electricity as possible and that in SOEC mode the amount of electrolysis product (e.g. H₂ and/or CO) is maximized. Stack lifetime depends on a number of factors, including the choice of the interconnect and spacer, on flow distribution on both process gas sides of the interconnect, evenly distributed protective coating on the materials, on the operating conditions (temperature, current density, voltage, etc), on cell design and materials, edge reoxidation which lowers the lifetime and many other factors.

### Cost:

The cost contribution of the interconnects (and spacers) can be reduced by not using noble materials, by reducing the production time of the interconnect and spacer, minimizing the number of components and by minimizing the material loss (the amount of material discarded during the production process).

### Dimensions:

The overall dimensions of a fuel stack are reduced, when the interconnect design ensures a high utilization of the active cell area. Dead-areas with low process gas flow should be reduced and inactive zones for sealing surfaces should be minimized.

### Production Time.

Production time of the interconnect and spacer itself should be minimized and the interconnect design should also contribute to a fast assembling of the entire stack. In general, for every component the interconnect design renders unnecessary, there is a gain in production time.

### Fail Rate.

The interconnect and spacer production methods and materials should permit a low interconnect fail rate (such as unwanted holes in the interconnect gas barrier, uneven material thickness or characteristics). Further the fail-rate of the assembled cell stack can be reduced when the interconnect design reduces the total number of components to be assembled and reduces the length and number of seal surfaces.

### Number of Components.

Apart from minimizing errors and assembling time as already mentioned, a reduction of the number of components leads to a reduced cost.

The way the anode and cathode gas flows are distributed in a SOC stack is by having a common manifold for each of the two process gasses. The manifolds can either be internal or external. The manifolds supply process gasses to the individual layers in the SOC stack by the means of channels to each layer. The channels are normally situated in one layer of the repeating elements which are comprised in the SOC stack, i.e. in the spacers or in the interconnect.

Interconnects and spacers which are made of sheet metal, are normally made of two separate parts of sheet material, which are sealed together in the SOC stack. This requires sealing between interconnect and spacer, plus handling of the separate components in the production. Furthermore, as the two separate sheet pieces often have the same outer dimensions, a lot of material, is wasted when most of the centre material of the spacer sheet is removed (e.g. stamped out).

Solid oxide electrolysis cells (SOEC) can be used to convert H2O to H2, CO2 to CO, or a combination of H2O and CO2 to syngas (H2 and CO). This conversion occurs on the cathode side of the SOEC, which comprises of Nickel containing layers in their reduced state. On the oxy side of the SOEC (the anode), oxygen is produced and is normally flushed with air.

The flush air and produced oxygen has to be supplied/removed from each SOEC anode in the stack, which is normally done by channels to/from each anode compartment to a common manifold (which can be internal or external). The common anode (oxy) manifold is thus connecting the individual single repeat units of the stack and spans across the individual cells of the stack at the cell edge.

The way the anode and cathode gas flows are distributed in a SOC stack is by having a common manifold for each of the two process gasses. The manifolds can either be internal or external. The manifolds supply process gasses to the individual layers in the SOC stack by the means of channels to each layer. The channels are normally situated in one layer of the repeating elements which are comprised in the SOC stack, i.e. in the spacers or in the interconnect.

Spacers or interconnects normally have one inlet channel which is stamped, cut or etched all the way through the material. The reason for only having one inlet channel is that the spacer has to be an integral component. This solution allows for a cheap and controllable manufacturing of the spacer or interconnect channel, because controllable dimensions give controllable pressure drops.

Another way of making process gas channels, which allows for multi channels, is by etching, coining, pressing or in other ways making a channel partly through the spacer or interconnect. This means that the spacer can be an integral component, but the method of making the channels partly through the material is not precise, which gives an uncertain and uncontrollable pressure-drop in the gas channels.

If a sealing material is applied across gas channels which are formed only partly through the material of the spacer or the interconnect, more uncertain and uncontrollable pressure-drops in the gas channels will arise. The sealing material can of course be screen printed to match only the desired surfaces, or glued and cut away from the gas channels, which will lower the risk of uncertain pressure-drops, but this is expensive and time-consuming.

Edge re-oxidation refers to a failure mechanism in SOC stacks where the Nickel in the cathode layer (SOEC mode) is gradually re-oxidized from stack or cell edges exposed to oxygen containing gas (e.g. the oxy manifold), eventually leading to loss of gas tightness, lower yield due to combustion and eventually hard failure of the stack due to electrolyte cracks. This is especially the case for stack design where the cell is not inserted into a frame or cassette but has the same footprint as the other components in the stack.

The stack with same footprint of the cell and the other components in the stack (“cell-to-edge”) is believed to be more robust towards thermal gradients and changes, as the sealing area is made of the same layers and material as the active area. There are thus no mis-match between the CET (Coefficient of Thermal Expansion) of the materials used in the sealing area and the active area. This will be the case for a stack concept with frame or cassettes, where the cell is not located in the sealing area—the stack thus has different CET in the active area compared with the sealing area.

If the cell edges, in a stack with same footprint of cell and the rest of the components, are covered/encapsulated in glass, used for sealing the individual components of the stack, the oxygen from the oxy manifold cannot diffuse into the Nickel containing layers and thus edge re-oxidation is avoided. The cell edge can be covered in glass if the edge of the cell is withdrawn slightly compared with the edge of the layers next to the cell, often the Oxy and fuel spacer, but for instance in some cases the interconnect.

One of the challenges when encapsulating the cell edge in glass, is that the glass will also enter the oxy channels in the oxy spacer running from the common oxy manifold to each anode compartment of each repeat unit in the SOEC stack. This can potentially block the oxy channels and disrupt the flush flow to or from the anode chamber.

U.S. Pat. No. 6,492,053 discloses a fuel cell stack including an interconnect and a spacer. Both, the interconnect and the spacer, have inlet and outlet manifolds for the flow of oxygen/fuel. The inlet and outlet manifolds have grooves/passages on its surface for the distribution of oxygen/fuel along the anode and cathode. However, the grooves/passages of the interconnect and spacer are not aligned with each other and hence their geometries could not be combined to achieve multiple inlet points. Also, since the grooves/passages are on the surface of both the interconnect and spacers, the formation of multiple inlet points are not feasible.

US2010297535 discloses a bipolar plate of a fuel cell with flow channels. The flow plate has multiple channels for distributing fluid uniformly between the active area of the fuel cell. The document does not describe a second layer and similar channels within it.

US2005016729 discloses a ceramic fuel cell (s) which is supported in a heat conductive interconnect plate, and a plurality of plates form a conductive heater named a stack. Connecting a plurality of stacks forms a stick of fuel cells. By connecting a plurality of sticks end to end, a string of fuel cells is formed. The length of the string can be one thousand feet or more, sized to penetrate an underground resource layer, for example of oil. A pre-heater brings the string to an operating temperature exceeding 700 DEG C., and then the fuel cells maintain that temperature via a plurality of conduits feeding the fuel cells fuel and an oxidant, and transferring exhaust gases to a planetary surface. A manifold can be used between the string and the planetary surface to continue the plurality of conduits and act as a heat exchanger between exhaust gases and oxidants/fuel.

None of the above described known art provides a simple, efficient and fail-safe solution to the above described problems.

Therefore, with reference to the above listed considerations, there is a need for a robust, simple, cheap and easy to produce and handle, multi-channel interconnect comprising one or more integrated gas manifold and channels for a SOC stack possibly also enabling covering the cell edge with glass.

These and other objects are achieved by the invention as described below.

### SUMMARY OF THE INVENTION

The invention is to make a single component (which combines the functionalities of the interconnect and spacer) in sheet metal by folding the spacer part from the IC sheet onto the one side of the sheet metal. Folding (or bending) is a mass preserving process, hence there is no waste. The folding radius is dependent of the sheet thickness, when folding thin sheet material as in the present invention, very small folding radius can be obtained.

By folding the spacer from the interconnect sheet metal, several issues are solved:
Reduction of sealing areas in the stack and thus fewer places where leak can occur, while saving a sealing layer per interconnect-spacer assembly.
Reduction of components to be handled in production.
As the spacer is made of the same sheet metal as the interconnect, the thickness of the interconnect and the spacer is the same, thus reducing tolerance issues in the stack assembly.
When spacers are made from a separate sheet metal, the material use is greater as the sealing area normally located in the periphery of the interconnect. The folded solution thus saves material, as the folded part is included in the interconnect periphery, and the “internal” of the spacer is used for interconnect.
Identical material of the interconnect and spacer (and no sealing material) yields same coefficient of thermal expansion.
As the spacer is part of the interconnect, the alignment of a separate spacer part is eliminated.
The folding process is cheap and industrial scalable.

To produce the integrated interconnect and spacer, the interconnect geometry is enlarged to include the spacers, which are then folded on top of the interconnect. The folding process is simple and robust and used in several industries (e.g. metal cans).

The thickness of the spacer is the same as the thickness of the interconnect. This reduces tolerances when assembling the stack. The same tolerances cannot be achieved by other processes, i.e. etching a seal between interconnect and spacer is saved. As the interconnect and spacer become one component, it saves on handling of components. As spacers are usually placed in the periphery of the interconnect, the centre is cut out and wasted using a standard solution. When the spacer is part of the interconnect, the internal of the spacer is not wasted, reducing material waste.

Furthermore, the invention includes integrated oxy channels “inside” the interconnect-spacer assembly of the SOC stack, which enables the oxy channels to be free from exposure to the glass used to encapsulate the edges of the cells.

The oxy channels are formed in both the interconnect and the spacer, but only a little more than half way through the sealing area in each component. The channels in the interconnect and the channels in the spacer then overlaps to create a single channel all the way through the sealing area.

This way, the outer edge of the Oxy spacer can be made without channels, enabling the coverage of the cell edge all over without having glass entering the oxy channels.

The invention yields a stack design with no or very low risk of edge re-oxidation while at the same time blocking of the oxy channels is avoided. It is to be understood that both the fuel and the oxy-spacers can be made according to the present invention for both SOEC and SOFC stacks as mentioned earlier.

The invention according to claim 1 is a Solid Oxide Cell stack comprising a plurality of stacked cell units. Each of the cell units comprises a cell layer, with anode, cathode and electrolyte and an interconnect layer. The layers are stacked alternating so that one interconnect layer separates one cell layer from the adjacent cell layer in the cell stack. The interconnect layer comprises an integrated interconnect and spacer which is made from one piece of plate with the thickness T, instead of having a separate spacer as known in the art. The spacer is formed by bending at least a part of the edges of the interconnect 180° a number, N, of time to provide a spacer which covers at least a part of the edges of the interconnect. It is to be understood that the bend is 180° with the tolerances which are inherent and common for the production process of bending, which may also include some degree of flexing back. Also, it is to be understood that the piece of plate to be bent before bending has dimensions larger than the final integrated interconnect and spacer, where the surplus area is to be bent and will form the spacer after the bend. After bending, the spacer and interconnect together form an edge of at least a part of the integrated interconnect and spacer with a thickness equal to or less than (1+N) times the thickness of the plate T. It is to be understood that the thickness depends of material and production tolerances which may lead to measures slightly above and below the exact thickness equal to or less than (1+N) times the thickness of the plate T, which is therefore within the scope of the claim. It is however a part of the invention that the bending process may also provide a higher accuracy than known from common solid oxide cell stacks, since a gasket between spacer and interconnect is omitted and because the bending process may be followed by an accurate press which evens the thickness of the integrated interconnect and spacer to fine tolerances. It is to be understood that contact between the cells by the integrated interconnect and spacer is ensured both by the bent edges as well as by contact points throughout the surface of the integrated interconnect and spacer. The contact points may be provided by a contact enabling element provided on the same side of the interconnect as the bent. The contact enabling element may be in the form of a net, by pressed contact points or any other known art. According to claim 1, the invention further comprises at least one primary gas inlet opening in at least one of said layers in at least one cell unit and wherein at least one adjacent layer in the same cell unit has at least one secondary gas inlet opening. The primary gas inlet opening partly overlap the secondary gas inlet opening and by doing so, the overlap defines a common gas inlet zone, where the inlet gas flows from the primary gas inlet opening to the secondary gas inlet opening, before the inlet gas flows further onto the active area of the cell. Accordingly, it is possible to make multi channels into every repeating element in the cell stack.

According to a further embodiment of the invention, the edge of the cell layer adjacent to said at least one primary gas inlet opening is retracted relative to the edge of the interconnect layer adjacent to said at least one primary gas inlet opening. Thus, a glass sealing is enabled to seal off the edge of the cell layer adjacent to said at least one primary gas inlet opening. Sealing of the edge is important to prevent edge re-oxidation of the cell layer, and according to this principle, the sealing will not block the gas inlet channels. The retracted edge of the cell layer relative to the edge of the adjacent interconnects is important to provide a stable and robust glass sealing of the edge of the cell layer. If for instance the glass sealing was merely added to an even/flush side of the solid oxide cell stack, there is a considerable risk that the glass sealing would fall off or detach during operation or operation cycles, since there are differences in the coefficient of thermal expansion (CET). According to this present embodiment of the invention however, the glass sealing is fixed between the “oversize” adjacent interconnect layers and is thus able to stick to and seal off the edge of the cell layer, preventing edge re-oxidation of the cell layer.

In a particular embodiment of the invention, at least part of the edges of the interconnect is bent 180° one time, which provides an interconnect and spacer with a thickness equal to or less than 2 times the thickness of the plate T.

When bent, the integrated interconnect and spacer may form at least one flow distributor for manifolding i.e. for the in- and outflow of process gasses to the stack, both from a part of the edge of the interconnect which is referred to as external manifolding and from channels located inside the interconnect area, which is referred to as internal manifolding. The edges to be bent may be formed and have gaps which allows process gas to flow into the stack, and the flow path may be oriented by the shape of the edges forming a flow distributor. The edges may for instance be formed as pins, wedges or any other shape adapted to allow for process fluid and guiding. This may be used both for internal manifolding as well as external manifolding as known in the art.

In an embodiment of the invention the spacer of the integrated interconnect and spacer forms at least one flow distributor, which defines said common gas inlet zone adapted for internal manifolding. The shape of the flow distributor may guide the gas flow to provide the best distribution of gas to the active area of the cell unit. Accordingly, in and embodiment of the invention, the spacer is at least partly formed by pins. The pins may be formed as wedges which are flow guides for a process fluid flow. Furthermore, said flow guides may at least partly overlap a part of said at least one primary gas inlet opening to form at least one multiple channel gas inlet according to an embodiment of the invention.

In an embodiment of the invention, the above described principle for a common gas inlet zone, may also be utilized for one or more common gas outlet zone where outlet gas flows from a primary gas outlet opening to a secondary gas outlet opening. Both the at least one primary gas inlet opening and/or the at least one primary gas outlet opening may be formed by a cut through hole, an etched through hole, a cut through opening, an indentation or a combination of these. Furthermore, the at least one primary gas inlet opening or the at least one primary gas outlet opening is located in the interconnect layer. Accordingly, the at least one secondary gas inlet opening and the at least one secondary gas outlet opening may be located in the spacer of the integrated interconnect and spacer.

Also, the spacer may be at least partly formed by a contiguous fluid tight edge. The fluid tight edge may be adapted to form a fluid tight seal towards an external manifold or around an internal manifold. Apart from the fold itself, the spacer may be further connected to the interconnect by diffusion bonding (wherein the atoms of two solid, metallic surfaces intersperse themselves over time), welding or any other suitable connecting technique on at least a part of the edge or surface of the spacer.

In an embodiment of the invention, the bend is facilitated and guided by grooves on one, the other, or both sides of the interconnect in at least a part of the bending lines. Grooves may be present on at least one side of the interconnect to form flow fields for process fluid. Said grooves may be formed by for instance etching.

In an embodiment of the invention, the stack is a Solid Oxide Electrolysis Cell stack with operating temperatures as mentioned above. In a further embodiment of the invention, the stack is a Solid Oxide Fuel Cell stack. The sheet metal used to manufacture the integrated interconnect and spacer may be austenitic steel, ferritic steel or any alloy best suited for the stack.

### FEATURES OF THE INVENTION

1. Solid Oxide Cell stack comprising a plurality of stacked cell units, each cell unit comprises a cell layer and an interconnect layer, one interconnect layer separates one cell layer from the adjacent cell layer in the cell stack, wherein the interconnect layer comprises an integrated interconnect and spacer made from one piece of plate with the thickness, T, the spacer is formed by at least a part of the edges of the interconnect which is bent 180° a number, N, of times to provide a spacer covering at least a part of the edges of the interconnect, so said spacer and interconnect together form an edge of at least a part of the integrated interconnect and spacer with a thickness equal to or less than (1+N) times the thickness of the plate T and wherein at least one of said layers in at least one cell unit has at least one primary gas inlet opening and wherein at least one adjacent layer in the same cell unit has at least one secondary gas inlet opening, wherein said primary gas inlet opening and said secondary gas inlet opening partly overlap, the overlap defines a common gas inlet zone where inlet gas flows from the primary gas inlet opening to the secondary gas inlet opening.

2. Solid Oxide Cell stack according to feature 1, wherein the edge of the cell layer adjacent to said at least one primary gas inlet opening is retracted relative to the edge of the interconnect layer adjacent to said at least one primary gas inlet opening, thereby enabling a glass sealing to seal off the edge of the cell layer adjacent to said at least one primary gas inlet opening.

3. Solid Oxide Cell stack according to any of the preceding features, wherein the at least part of the edges of the interconnect is bent 180° one time to provide a spacer covering at least a part of the edges of the interconnect, so said spacer and interconnect together form an edge of at least a part of the integrated interconnect and spacer with a thickness equal to or less than 2 times the thickness of the plate T.

4. Solid Oxide Cell stack according to any of the preceding features, wherein the spacer of the integrated interconnect and spacer further forms at least one flow distributor for manifolding.

5. Solid Oxide Cell stack according to any of the preceding features, wherein the spacer of the integrated interconnect and spacer further forms at least one flow distributor adapted for external manifolding.

6. Solid Oxide Cell stack according to any of the preceding features, wherein the spacer of the integrated interconnect and spacer further forms at least one flow distributor which defines said common gas inlet zone adapted for internal manifolding.

7. Solid Oxide Cell stack according to any of the preceding features, wherein the spacer of the integrated interconnect and spacer is at least partly formed by pins.

8. Solid Oxide Cell stack according to any of the preceding features, wherein the spacer of the integrated interconnect and spacer is at least partly formed by pins formed as wedges which are flow guides for a process fluid flow.

9. Solid Oxide Cell stack according to feature 8, wherein said flow guides at least partly overlap a part of said at least one primary gas inlet opening and thereby form at least one multiple channel gas inlet.

10. Solid Oxide Cell stack according to any of the preceding features, wherein at least one of said layers in at least one cell unit has at least one primary gas outlet opening and wherein at least one adjacent layer in the same cell unit has at least one secondary gas outlet opening, wherein said primary gas outlet opening and said secondary gas outlet opening partly overlap, the overlap defines a common gas outlet zone where outlet gas flows from the primary gas outlet opening to the secondary gas outlet opening.

11. Solid Oxide Cell stack according to any of the preceding features, wherein the at least one primary gas inlet opening or the at least one primary gas outlet opening is a cut through hole, an etched through hole, a cut through opening, an indentation or a combination of these.

12. Solid Oxide Cell stack according to any of the preceding features, wherein the at least one primary gas inlet opening or the at least one primary gas outlet opening is located in the interconnect layer.

13. Solid Oxide Cell stack according to any of the preceding features, wherein the spacer of the integrated interconnect and spacer is at least partly formed by a contiguous fluid tight edge.

14. Solid Oxide Cell stack according to any of the preceding features, wherein the spacer of the integrated interconnect and spacer is at least partly formed by a contiguous fluid tight edge adapted to form a fluid tight seal towards an external manifold.

15. Solid Oxide Cell stack according to any of the preceding features, wherein the spacer of the integrated interconnect and spacer is at least partly formed by a contiguous fluid tight edge adapted to form a fluid tight seal around an internal manifold.

16. Solid Oxide Cell stack according to any of the preceding features, wherein the spacer is connected to the interconnect not only by the bent part, but additionally on at least one further edge or surface of the spacer facing the interconnect.

17. Solid Oxide Cell stack according to any of the preceding features, wherein the spacer is connected to the interconnect by diffusion bonding on at least a part of the surface of the spacer facing the interconnect.

18. Solid Oxide Cell stack according to any of the preceding features, wherein the spacer is connected to the interconnect by welding on at least a part of the surface of the spacer facing the interconnect.

19. Solid Oxide Cell stack according to any of the preceding features, wherein the interconnect has grooves on at least one side adapted to facilitate and guide said 180° a number, N, of times bend.

20. Solid Oxide Cell stack according to any of the preceding features, wherein the interconnect has grooves on at least one side adapted to form flow fields for process fluid.

21. Solid Oxide Cell stack according to any of the preceding features, wherein the interconnect has grooves formed by etching on at least one side to form flow fields for process fluid.

22. Solid Oxide Cell stack according to any of the preceding features, wherein the Solid Oxide Cell stack is a Solid Oxide Electrolysis Cell stack.

### BRIEF DESCRIPTION OF THE DRAWINGS

The invention is further illustrated by the accompanying drawings showing examples of embodiments of the invention.

FIG. 1 shows an oxy side view of an integrated interconnect, spacer and manifold before folding according to an embodiment of the invention.

FIG. 2 shows a fuel side view of an integrated interconnect, spacer and manifold before folding according to an embodiment of the invention.

FIG. 3 shows a detail view of the fuel side of an integrated interconnect, spacer and manifold after folding.

FIG. 4 shows a detail view of the oxy side of an integrated interconnect, spacer and manifold after folding.

FIG. 5 shows a transparent detail view of the fuel side of an integrated interconnect, spacer and manifold after folding.

FIG. 6 shows side cut detail view of a number of stacked cell units.

FIG. 7 shows side cut detail view with explanatory text of a number of stacked cell units.

FIG. 8 shows side cut detail view of a number of stacked cell units.

### POSITION NUMBERS

01. Integrated interconnect, spacer and manifold
02. Spacer
03. Flow distributor adapted for external manifolding
04. Flow distributor adapted for internal manifolding
05. Pins
06. Primary gas inlet opening
07. Secondary gas inlet opening
08. Cell layer
09. Glass sealing

### DETAILED DESCRIPTION

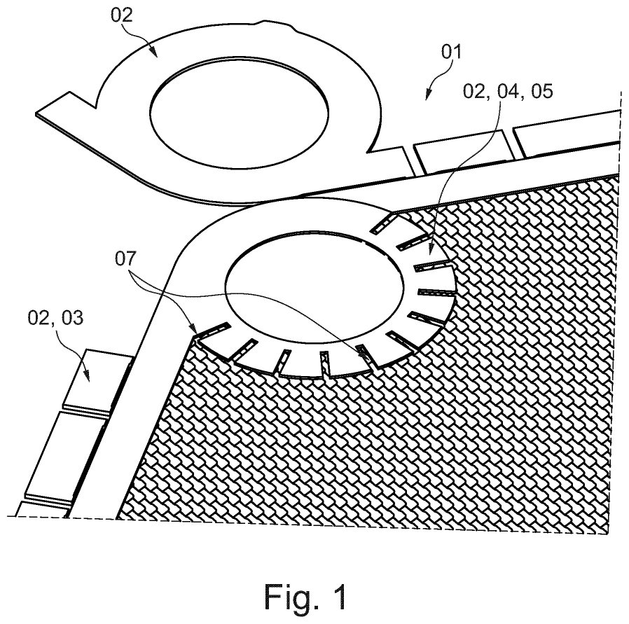

FIG. 1 shows an integrated interconnect, spacer and manifold 01 for a Solid Oxide Cell stack (not shown). FIG. 1 shows the interconnect as one flat piece of sheet metal with surplus material along the edge adapted to form the spacers 02, but before the folding, hence some of the spacers have not yet been formed. The side shown is the oxy side of the integrated interconnect, spacer and manifold. The oxy side comprises integrated spacers and contact points which may be formed by etching material away from the oxy side. As can be seen, also secondary gas inlet openings 07 may be formed in the oxy side, also in an embodiment done by etching away material. The secondary gas inlet openings are separated by spacers in the form of pins 05, which serve to guide the inlet gas flow to evenly distribute it to the flow field of the integrated interconnect, spacer and manifold and thus to the adjacent active area of the cell layer (not shown). The secondary inlet openings are in fluid contact with the primary gas inlet openings in an adjacent layer in the same cell unit (seen in the following Fig.) and further with the internal manifold here seen as a hole in the integrated interconnect, spacer and manifold.

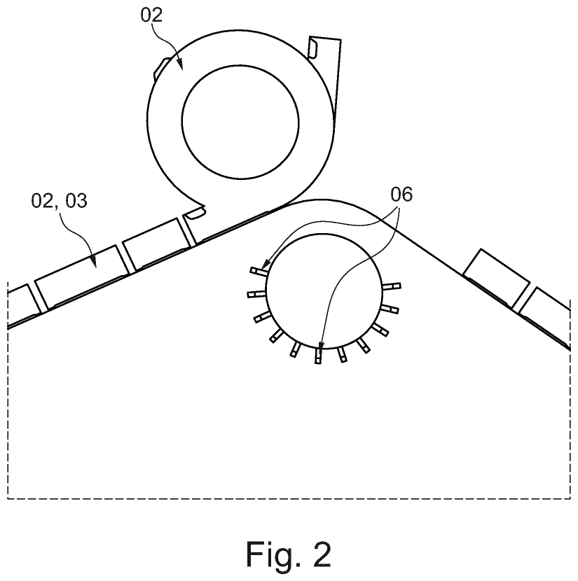

FIG. 2 shows the same part of the integrated interconnect, spacer and manifold as FIG. 1, only seen from the opposite, the fuel side of the integrated interconnect, spacer and manifold. Still the surplus material has not yet been folded, and thus the fuel side spacers have not yet been formed. However, this leaves the primary gas inlet openings 06 for the oxy side visible. They are as mentioned in fluid contact with the secondary gas inlet openings because even though they are formed in an adjacent layer of the integrated interconnect, spacer and manifold, they overlap with the secondary gas inlet openings. They may in an embodiment be formed by etching away material, and thus the integrated interconnect, spacer and manifold may be etched on two sides. It is to be noted also that some of the fuel spacers are spaced apart, thereby leaving a fluid passage free and acting as flow distributors adapted for external manifolding 04 of the fuel flow once they are folded.

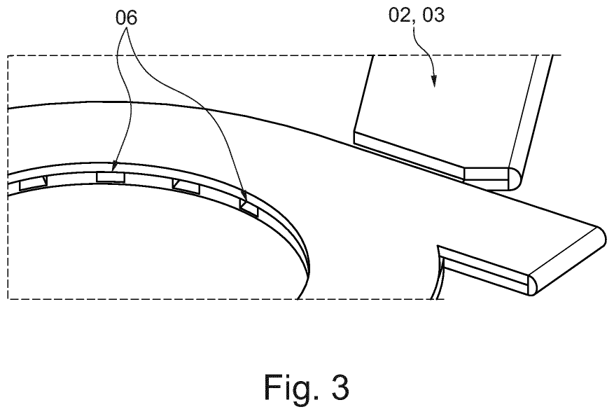

On FIG. 3, the surplus material of the interconnect shown in FIG. 1 has now been folded 180° onto the top side of the interconnect to form spacers around the edges of the interconnect as well as around the internal manifold throughholes cut in the interconnect for the oxy side. It is to be understood that the spacers adapted for manifolding may be formed in different shapes to control and direct the fluid flow to, along and from the interconnect. One spacer in FIG. 3 is formed with a contiguous fluid tight edge, which when folded forms an edge around the internal manifold, through-hole in the periphery of the interconnect on the fuel side. As can be seen, this blocks flow passage from the internal oxy manifold to the fuel side, only allowing the oxy gas to flow through the primary gas inlet openings and further on to the secondary gas inlet openings as explained.

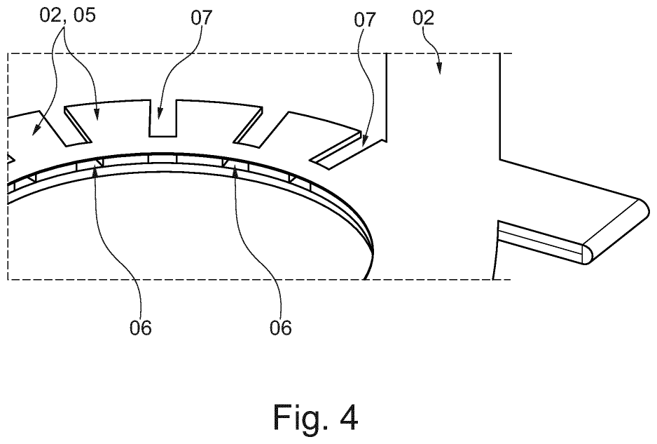

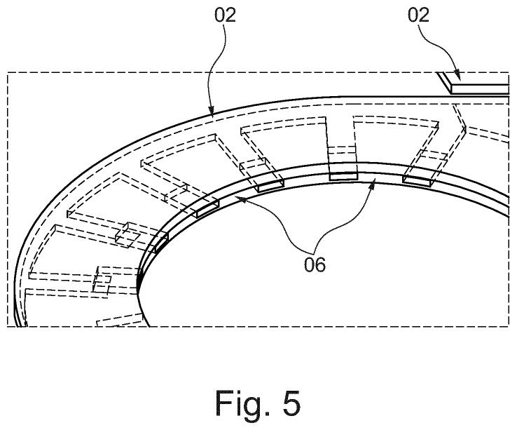

FIG. 4 shows the same folded integrated interconnect, spacer and manifold as seen in FIG. 3, only seen from the opposite, the oxy side of the interconnect. In this detailed view in FIG. 4, both the primary and the secondary gas inlet openings are shown, and it can be seen how they are in fluid flow connection even though they are in different layers, because they overlap according to the invention. The same detail only in transparent view is shown in FIG. 5, to again visualize the fluid connection of the primary and secondary gas inlet openings.

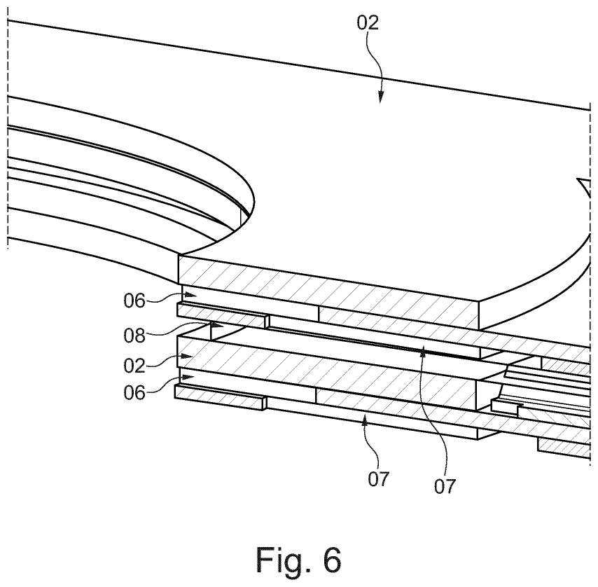

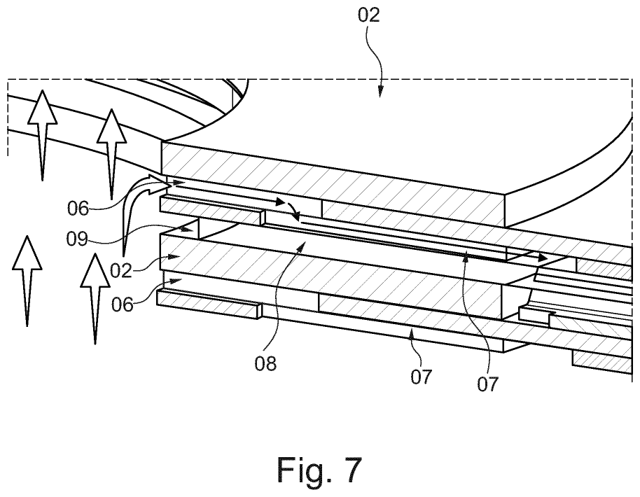

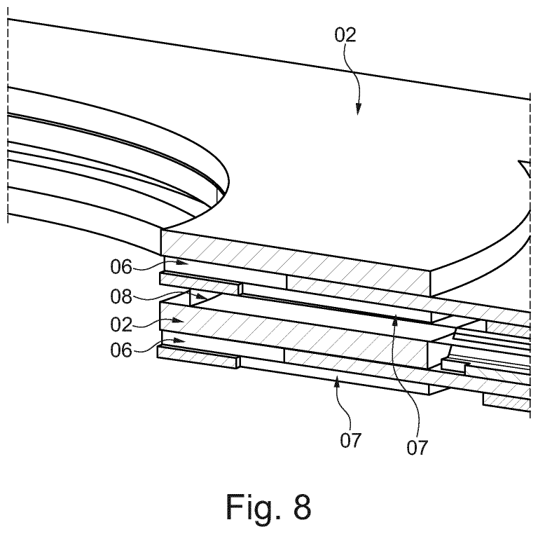

Again, the same detail is shown in FIGS. 6, 7 and 8, however this time shown in a side-cut view and with two integrated interconnect, spacer and manifold stacked around one cell layer 08. As can be seen the edge of the cell layer near the internal manifold hole is retracted relative to the edge of the interconnect layers. This provides just enough space for a glass sealing 09 to seal off the edge of the cell layer, be mechanically held in place by the interconnect layers and thereby preventing edge re-oxidation of the cell. In FIG. 7, the oxy fluid flow is visualized with arrows, showing how the oxy fluid flows through the internal manifold channel formed by the holes in the stacked layers, further through the primary gas inlet openings, the secondary gas inlet openings and into the flow field on the oxyside of the interconnect layers where it contacts the active area of the cell layer.

### Example

Experiments have shown that it is indeed possible to fold the interconnect and thereby provide an edge portion which is also an integrated spacer. A light-optical microscopy picture of the folded edge of the integrated interconnect and spacer shows that flow channels may be provided and that it is possible to “wrap up” the cell edge in glass sealing.

1. Solid Oxide Cell stack comprising a plurality of stacked cell units, each cell unit comprises a cell layer and an interconnect layer, one interconnect layer separates one cell layer from the adjacent cell layer in the cell stack, wherein the interconnect layer comprises an integrated interconnect and spacer made from one piece of plate with the thickness, T, the spacer is formed by at least a part of the edges of the interconnect which is bent 180° a number, N, of times to provide a spacer covering at least a part of the edges of the interconnect, so said spacer and interconnect together form an edge of at least a part of the integrated interconnect and spacer with a thickness equal to or less than (1+N) times the thickness of the plate T and wherein at least one of said layers in at least one cell unit has at least one primary gas inlet opening and wherein at least one adjacent layer in the same cell unit has at least one secondary gas inlet opening, wherein said primary gas inlet opening and said secondary gas inlet opening partly overlap, the overlap defines a common gas inlet zone where inlet gas flows from the primary gas inlet opening to the secondary gas inlet opening.

2. Solid Oxide Cell stack according to claim 1, wherein the edge of the cell layer adjacent to said at least one primary gas inlet opening is retracted relative to the edge of the interconnect layer adjacent to said at least one primary gas inlet opening, thereby enabling a glass sealing to seal off the edge of the cell layer adjacent to said at least one primary gas inlet opening.

3. Solid Oxide Cell stack according to claim 1, wherein the at least part of the edges of the interconnect is bent 180° one time to provide a spacer covering at least a part of the edges of the interconnect, so said spacer and interconnect together form an edge of at least a part of the integrated interconnect and spacer with a thickness equal to or less than 2 times the thickness of the plate T.

4. Solid Oxide Cell stack according to claim 1, wherein the spacer of the integrated interconnect and spacer further forms at least one flow distributor for manifolding.

5. Solid Oxide Cell stack according to claim 1, wherein the spacer of the integrated interconnect and spacer further forms at least one flow distributor adapted for external manifolding.

6. Solid Oxide Cell stack according to claim 1, wherein the spacer of the integrated interconnect and spacer further forms at least one flow distributor which defines said common gas inlet zone adapted for internal manifolding.

7. Solid Oxide Cell stack according to claim 1, wherein the spacer of the integrated interconnect and spacer is at least partly formed by pins.

8. Solid Oxide Cell stack according to claim 1, wherein the spacer of the integrated interconnect and spacer is at least partly formed by pins formed as wedges which are flow guides for a process fluid flow.

9. Solid Oxide Cell stack according to claim 8, wherein said flow guides at least partly overlap a part of said at least one primary gas inlet opening and thereby form at least one multiple channel gas inlet.

10. Solid Oxide Cell stack according to claim 1, wherein at least one of said layers in at least one cell unit has at least one primary gas outlet opening and wherein at least one adjacent layer in the same cell unit has at least one secondary gas outlet opening, wherein said primary gas outlet opening and said secondary gas outlet opening partly overlap, the overlap defines a common gas outlet zone where outlet gas flows from the primary gas outlet opening to the secondary gas outlet opening.

11. Solid Oxide Cell stack according to claim 1, wherein the at least one primary gas inlet opening or the at least one primary gas outlet opening is a cut through hole, an etched through hole, a cut through opening, an indentation or a combination of these.

12. Solid Oxide Cell stack according to claim 1, wherein the at least one primary gas inlet opening or the at least one primary gas outlet opening is located in the interconnect layer.

13. Solid Oxide Cell stack according to claim 1, wherein the spacer of the integrated interconnect and spacer is at least partly formed by a contiguous fluid tight edge.

14. Solid Oxide Cell stack according to claim 1, wherein the spacer of the integrated interconnect and spacer is at least partly formed by a contiguous fluid tight edge adapted to form a fluid tight seal towards an external manifold.

15. Solid Oxide Cell stack according to claim 1, wherein the spacer of the integrated interconnect and spacer is at least partly formed by a contiguous fluid tight edge adapted to form a fluid tight seal around an internal manifold.

16. Solid Oxide Cell stack according to claim 1, wherein the spacer is connected to the interconnect not only by the bent part, but additionally on at least one further edge or surface of the spacer facing the interconnect.

17. Solid Oxide Cell stack according to claim 1, wherein the spacer is connected to the interconnect by diffusion bonding on at least a part of the surface of the spacer facing the interconnect.

18. Solid Oxide Cell stack according to claim 1, wherein the spacer is connected to the interconnect by welding on at least a part of the surface of the spacer facing the interconnect.

19. Solid Oxide Cell stack according to claim 1, wherein the interconnect has grooves on at least one side adapted to facilitate and guide said 180° a number, N, of times bend.

20. Solid Oxide Cell stack according to claim 1, wherein the interconnect has grooves on at least one side adapted to form flow fields for process fluid.

21. Solid Oxide Cell stack according to claim 1, wherein the interconnect has grooves formed by etching on at least one side to form flow fields for process fluid.

22. Solid Oxide Cell stack according to claim 1, wherein the Solid Oxide Cell stack is a Solid Oxide Electrolysis Cell stack.
